(19) United States
(12) Patent Application Publication
(10) Pub. No.: US 2007/0245518 A1
(43) Pub. Date: Oct. 25, 2007

(54) Safety Apparatus for a Door or Window

(76) Inventor: James Blair, Staffordsville, KY (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 11/379,714

(22) Filed: Apr. 21, 2006

(51) Int. Cl. E05F 5/06

(52) U.S. Cl. 16/85

(57) ABSTRACT

A safety apparatus for a door is disclosed, the safety apparatus comprising a first member mounted to a door frame and a second member communicating within the first member in response to an outwardly biased spring. A guide is formed on a wall of the first member. A dowel pin projects from the second member, wherein the dowel pin communicates with the guide. The guide has at least a first pathway receiving the dowel pin to allow the door to close. The spring has torque along the length of the spring for urging movement of the dowel pin within the first pathway so that the door may close.

### RELATED U.S. APPLICATION DATA

Not applicable.

### FIELD OF THE INVENTION

This invention relates generally to a door stop, and more specifically, to a safety apparatus coupled to a door frame for use in inhibiting a door from closing if too much force has been applied to the door, such as with a sliding door, as one example.

### BACKGROUND OF THE INVENTION

Numerous devices and apparatuses have been provided for operating as a safety apparatus to prevent doors from slamming against walls, overextending and damaging the hinge, and the like, while other devices and apparatuses have been provided that firmly lock or hold a door in a specific position. However, there does not appear to be a device or apparatus that may be mounted to a door frame and utilized to prevent the door from slamming into the frame and potentially pinching fingers, hands, or quick moving animals between the door and the door frame.

The following U.S. Patents are considered relevant to the present invention, though the following patents fail to disclose the particular elements, features and functions of the present invention. U.S. Pat. No. 6,487,752 (issued to Matthews) discloses a sliding door stop that is positioned within the header of a sliding door frame. The door stop is placed within a header, the door stop having bumpers for abutting against the door when necessary. However, the Matthews patent addresses the amount of overlap that is available between two panels of a sliding glass door unit.

Several patents that offer a braking system for doors, including U.S. Pat. Nos. 6,553,617 ('617) and 6,408,483 ('483) (both issued to Salice) and 4,872,239 ('239) (issued to Ferguson et al.). In the '617 patent, an apparatus having a piston and piston rod communicating within a cylinder is provided, in which a spring is utilized for resisting compression exerted by the piston and piston rod. The '483 patent describes another braking apparatus similar to the '617 patent, with the exception that the '483 patent utilizes a cod wheel corresponding to a plurality of teeth along the length of a piston. The '239 patent discloses a braking means similar to those used on an exterior hinged door (e.g. a storm door), operating to slowly shut the door and not allow it to slam or bang off of the frame. However, these patents do not disclose an apparatus that is reactive to excessive momentum of a door or window and inhibits the door or window from traveling beyond a specified distance.

Other patents considered relevant include U.S. Pat. Nos. 6,584,642 (issued to Hodson—door stop and restraint), 6,874,198 and 6,487,751 (both issued to Renaud—door safety devices), 4,159,837 (issued to Morita—door stop and latching device), 4,760,621 (issued to Stromquist—doorstop, holdopen and shock absorber).

Sliding doors may serve as one particular example of the types of safety hazard(s) that doors possess. For instance, a sliding glass door of the type often utilized in homes and hotels for ingress and egress to a porch or veranda is often a heavy object because of the thickness and weight of the glass and the size of the frame and the metal utilized. In one example, a sliding glass door panel weighed approximately sixty (60) pounds. Children and some adults may have a difficult time in establishing the balance and exerting the proper force on a sliding glass door in order to close the door. This problem is particularly acute with children, who will often get an arm, a hand, or fingers between the door and the door frame after mustering enough strength to get the door sliding toward closing. This can result in devastating and potentially life altering injuries, including severe muscle and nerve damage, or near-amputation of a limb or digits. In addition, a house pet is generally notorious for following very closely behind the owner, and if the pet tries to “beat” the sliding glass door that is closing behind the owner, sometimes the house pet may get nicked or pinned by the door, thus injuring or killing the pet. According to one Consumer Product Safety Commission (CPSC) report, since 1998, there have been approximately 670 reported injury incidents related to sliding glass doors alone, with approximately 96% involving fingers, hands, wrists and arms, and with a surprising number of finger amputations (19) and at least one hand amputation. The present invention provides a safety apparatus for a door that prevents these hazards from resulting in injury by stopping doors that have excessive force imparted thereon.

### SUMMARY OF THE INVENTION

In one embodiment of the present invention, a safety apparatus for a door is disclosed, the safety apparatus comprising a first member mounted to a door frame and a second member communicating within the first member in response to an outwardly biased spring. A guide is formed on a wall of the first member. A dowel pin projects from the second member, wherein the dowel pin communicates with the guide. The guide has at least a first pathway receiving the dowel pin to allow the door to close. The spring has torque along the length of the spring for urging movement of the dowel pin within the first pathway so that the door may close.

In another embodiment of the present invention, a safety apparatus for a door is disclosed, the safety apparatus comprising a first member having a recess and a guide formed in a wall, the first member mounted to a door frame. The safety apparatus also has a second member communicating with the recess in response to an outwardly biased spring housed in the recess and coupled to the first member and the second member. A dowel pin projects from a wall of the second member, the dowel pin communicates with the guide. The guide has at least a first pathway and a second pathway, the first pathway receives the dowel pin to allow the door to close, and the second pathway receives the dowel pin to inhibit the door from closing. The spring is coupled to a closed end of the first member and a closed end of the second member that communicates with the recess.

The spring has torque along the length of the spring for urging movement of the pin within the first pathway so that the door may close. An end of the spring is coupled to the first member and an opposing end of the spring coupled to the second member, wherein the spring is oriented so that torque is generated and stored until the door engages the second member. If the momentum and force of the door is not sufficient to overcome the torque, the spring urges the pin into the first pathway and permits closure of the door. If the momentum and force of the door is sufficient to overcome the torque, and especially violent, the spring urges the pin away from the first pathway and inhibits closure of the door.

In another embodiment of the present invention, a safety apparatus for a door is disclosed, the safety apparatus comprising a first member having at least one wall upstanding from an enclosed end and forming or defining a recess. The first member has a guide formed in the at least one wall or cap coupled to the first member, and the first member is mounted to a door frame. The safety apparatus also includes a second member having at least one wall upstanding from enclosed and opposing ends, and the second member is placed within the recess of the first member. The second member reciprocates within the recess in response to an outwardly biased spring housed in the recess and coupled to the first member and the second member. A dowel pin projects from the at least one wall of the second member, and the dowel pin communicates with the guide. The guide has three (interconnected) pathways, the first pathway receiving the dowel pin to allow the door to close, the second pathway receiving the dowel pin to inhibit the door from closing, and the third pathway receiving the dowel pin to release the dowel pin from the guide for removing the second member from the first member. The spring is coupled to the closed end of the first member and the closed end of the second member. The spring is positioned to have or possess torque along its length, wherein the torque urges movement of the pin within the first pathway so that the door may close.

The coupling of the spring is oriented so that torque is generated and stored until the door engages the second member, and whereby the momentum and force of the door is not sufficient to overcome the torque and the spring urges the dowel pin into the first pathway and permits closure of the door. The momentum and force of the door is sufficient to overcome the torque and the spring urges the dowel pin into the second pathway and inhibits closure of the door. The dowel pin may have a variety of configurations, including the cylinder and the tear-drop shapes depicted and described.

As discussed above, the method and device of the present invention overcomes the disadvantages inherent in prior art methods and devices. In this respect, before explaining at least one embodiment of the invention in detail, it is to be understood that the invention is not limited in its application to the details of construction and to the arrangement of the components set forth in the following description or illustrated in the drawings. The invention is capable of other embodiments and of being practiced and carried out in various ways. It is to be understood that the phraseology and terminology employed herein are for the purpose of description and should not be regarded as limiting.

The coupling of the spring is oriented so that torque is generated and stored until the door engages the second member, and whereby the momentum and force of the door is not sufficient to overcome the torque and the spring urges the dowel pin into the first pathway and permits closure of the door. The momentum and force of the door is sufficient to overcome the torque and the spring urges the dowel pin into the second pathway and inhibits closure of the door. The apparatus further comprises a fourth pathway for locking the second member into a fixed position relative to the first member. The apparatus may include a face having a strike plate and/or a cushioned surface to lessen damage upon impact of the door to the face.

Accordingly, those skilled in the art will appreciate that the conception upon which this invention is based may readily be utilized as a basis for the design of other structures, methods, and systems for carrying out the several purposes of the present invention. It is important, therefore, that the claims be regarded as including such equivalent constructions insofar as they do not depart from the spirit of the present invention.

Furthermore, the purpose of the foregoing Abstract is to enable the U.S. Patent and Trademark Office and the public generally, and especially including the practitioners in the art who are not familiar with patent or legal terms or phraseology, to determine quickly from a cursory inspection, the nature and essence of the technical disclosure of the application. The Abstract is neither intended to define the invention of the application, nor is it intended to be limiting to the scope of the invention in any way. It is intended that the application is defined by the claims.

### BRIEF DESCRIPTION OF THE DRAWINGS

Additional utility and features of the invention will become more fully apparent to those skilled in the art by reference to the following drawings, which illustrate the primary features of the preferred embodiment and numerous alternative embodiments.

FIG. 1 is a front or rear view of the safety apparatus coupled to the door and door unit as embodied in a sliding glass door unit, the circle indicating the general location of the apparatus;

FIG. 2 is an exploded perspective view of the safety apparatus;

FIG. 3a is a perspective view of the safety apparatus deployed to a position corresponding with the resting or starting state of the apparatus;

FIG. 3b is a perspective view of the safety apparatus deployed to a position corresponding to a second pathway and corresponding to inhibiting the door from closing;

FIG. 3c is a perspective view of the safety apparatus deployed to a position corresponding to a first pathway and corresponding to allowing the door to close;

FIG. 4a and FIG. 4b are a side view and a top view, respectively, of the first member;

FIG. 4c is a front view of the mounting flange;

FIG. 5 is a top or bottom sectional view taken through line V-V of FIG. 3a of the safety apparatus corresponding to the normal or starting position of the second member with the outwardly biased spring fully extended;

FIG. 6 is a top or bottom sectional view taken through line VI-VI of FIG. 3c of the safety apparatus corresponding to the position in which the dowel pin travels along the first pathway and the second member fully compressing the spring fully;

FIG. 7 is a top or bottom sectional view taken through line VII-VII of FIG. 3b of the safety apparatus corresponding to the position in which the dowel pin inhibits the travel of the second member, and thus inhibits the door from closing, the dowel pin position corresponding to position “C” in the description provided herein;

FIG. 8 is a top view of the first member and the guide formed thereon, wherein in this depiction the guide has three pathways;

FIG. 9 is a top view of the first member and an alternate embodiment of the guide, wherein in this depiction the guide has two pathways;

FIG. 10 is a top view similar to that of FIG. 8 depicting an alternate embodiment of the dowel pin having a tear drop shape (rather than a cylindrical shape).

### DETAILED DESCRIPTION OF THE PREFERRED EMBODIMENT

The detailed description below is for preferred embodiments and is intended to explain the current invention. It is to be understood that a variety of other arrangements are also possible without departing from the spirit and scope of the invention.

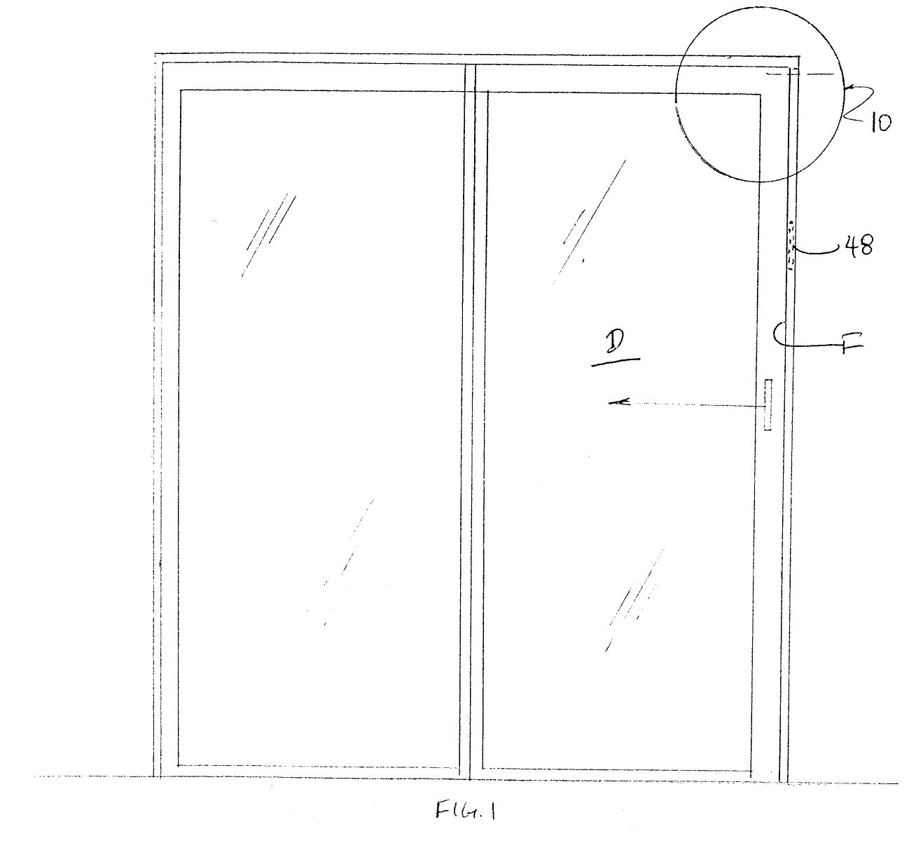

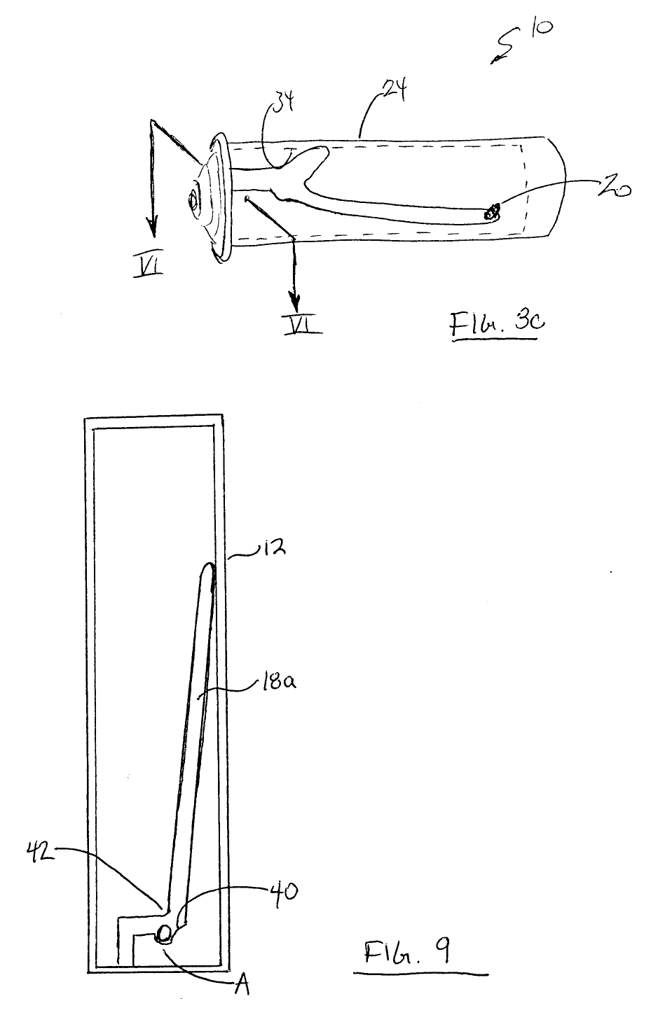

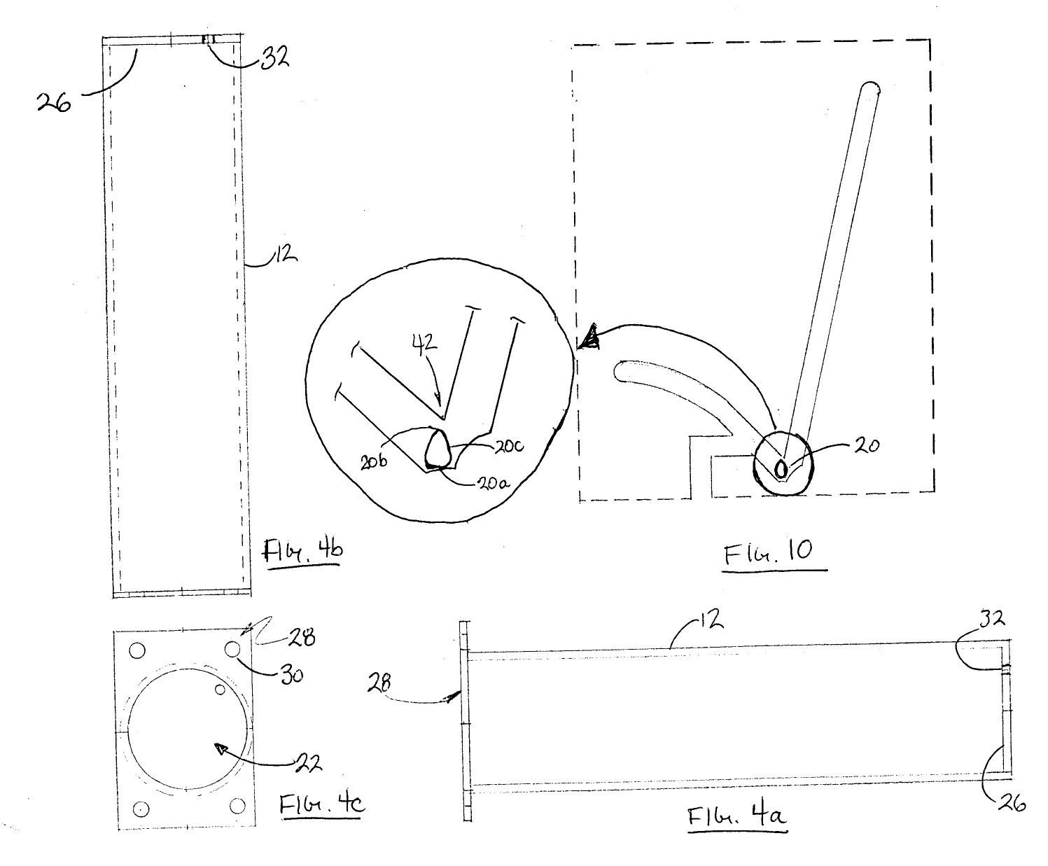

Referring now to FIG. 1 through FIG. 8, a safety apparatus 10 for a door D is disclosed in accordance with one embodiment of the present invention. The safety apparatus 10 comprises a first member 12 mounted to a door frame F and a second member 14 communicating within the first member 12 in response to an outwardly biased spring 16. A guide 18 is formed on a wall 20 of the first member 12. A dowel pin 20 projects from the second member 14, wherein the dowel pin 20 communicates with the guide 18. The guide 18 has at least a first pathway 18a receiving the dowel pin 20 to allow the door to close. The spring 16 has torque T along the length of the spring 16 for urging movement of the dowel pin 20 within the first pathway 18a so that the door D may close.

The first member 12 may have a recess 22 for receiving and accommodating the reciprocating communication of the second member 14 therein. The recess 22 may be formed by and defined by at least one wall 24 upstanding from an enclosed end 26. The enclosed end 26 may be integral with the at least one wall 24 or may be a separate cap or enclosure 26 as depicted in FIG. 2. The at least one wall 24 may comprise a continuous wall defining a circular path and forming a cylindrically shaped first member 12. Other geometries are contemplated and envisioned. The first member 12 may include an integral or separately coupled mounting flange 28 having a plurality of apertures 30, in which the mounting flange 28 is utilized for mounting the first member 12 to the frame F via mechanical fasteners (including screws, bolts, nails and other similar objects). The first member 12 may also include a hole 32 utilized for anchoring one end of the spring 16 within the recess 22 of the first member 12.

The second member 14 has at least one wall 34 upstanding from an enclosed and opposing ends 36a and 36b. The at least one wall 34 may comprise a continuous wall defining a circular path and forming a cylindrically shaped second member 14, and thus forming an enclosed cylindrical structure. Other geometries are contemplated and envisioned. The second member 14 is placed within the recess 22 of the first member 12, and reciprocates within the recess 22 in response to the outwardly biased spring 16 housed in the recess 22 and coupled to the first member 12 and the second member 14. One end 36a may have a hole 39 for receiving one end of the spring 16, thereby anchoring the spring 16 to an end 36a of the second member 14. This end 36a is adjacent to and communicates with the recess 22 of the first member 12 when the members 12 and 14 are coupled and engaged for use. The opposite end 36b may have a face 38 that engages and communicates with the door D. The face 38 may be coupled to or affixed to the end 36b by any number of means 46, including chemical bonding agents, mechanical fasteners, and other similar objects, including the threaded screw depicted in FIG. 2. The face 38 may include a strike plate or other raised, padded and/or cushioned structure so as to absorb excessive energy imparted on the door D and to prevent the face 38 from marring or damaging the vertical portion of the door D. It is envisioned that the first member 12 and the second member 14 may be manufactured or fabricated from a variety of materials, including metal, plastic, rubber, synthetic material and wood, among other suitable materials.

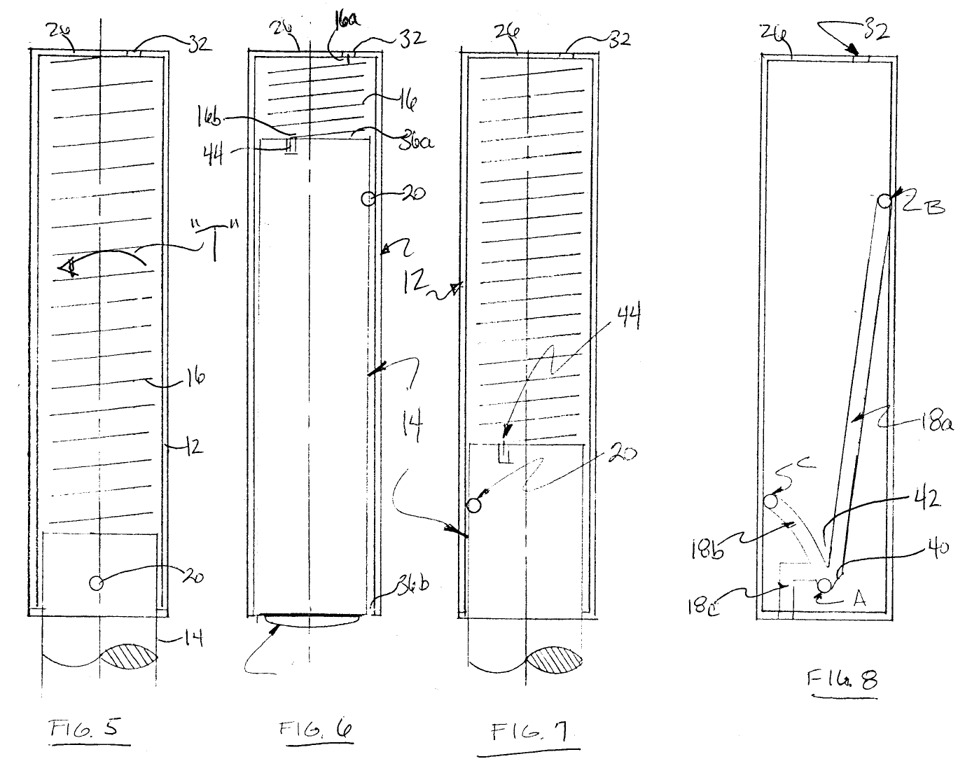

The first member 12 also includes the guide 18 formed in the at least one wall 24 of the first member 12. As depicted in FIG. 2, FIG. 8 and FIG. 9, the guide 18 has at least one pathway (denoted hereinafter as “first pathway”) 18a for receiving the dowel pin 20 and traveling along a path so that the door D may close. The path is denoted as “A-B”, wherein “A” is a starting position and “B” is finishing position. The dowel pin 20 travels from position “A” to position “B” and a distance corresponding to the distance that the second member 14 must travel to substantially enter the recess 22 of the first member 12 and permit the door D to engage the vertical portion of the door frame F. The guide 18 may have a second pathway 18b for receiving the dowel pin 20 and traveling along a path so that the door D is inhibited from closing, and so that the door D does not engage the door frame F. The path along the second pathway 18b is denoted as “A-C”, wherein “A” is a starting position and “C” is a finishing position. The dowel pin 20 travels from position “A” to position “C” and a distance corresponding to the distance that inhibits the second member 14 from substantially entering the recess 22 of the first member 12, and thus, inhibiting the door D from engaging the vertical portion of the door frame F. The guide 18 may also have a third pathway 18c for receiving the dowel pin 20 to release the dowel pin 20 from the guide 18 and thereby freeing the second member 14 for removal from the first member 12, and thus disengaging the members 12 and 14 from one another.

In one embodiment, and as depicted in FIG. 8, the guide 18 may have three pathways 18a, 18b and 18c, respectively, interconnected with one another, in which the pathways differ from one another so as to achieve different aims or goals. For instance, the first pathway 18a may be described as substantially linear, while the second pathway 18b may be described as substantially curvilinear, and the third pathway 18c may be described as being linear in two different and perpendicular directions (when viewing this feature from above, the pathway 18c has an L-shape). Adjacent to the starting position “A” of the dowel pin 20, and intermediately disposed between the starting position “A” and the entrance of the first pathway 18a is a bumper 40 for urging the dowel pin 20 within the first pathway 18a. The dowel pin 20 will engage the bumper 40 only if the force of the door D is not excessive and does not exceed the torque T energy placed on the spring 16. In this situation, then the bumper 40 will urge the dowel pin 20 into the entrance and along the path of the first pathway 18a until position “B” is reached and the door is closed. The guide 18 may also include an abutment or deflector 42 for urging the dowel pin 20 within the second pathway 18b. The dowel pin 20 will engage the abutment or deflector 42 if the force of the door D exceeds the torque T energy placed on the spring 16. In this situation, the abutment or deflector 42 will inhibit the dowel pin 20 from entering into the first pathway 18a and instead directs the dowel pin 20 into the second pathway 18b and toward position “C”, thereby inhibiting the door from closing. The second pathway 18b length will determine the distance that the door D is separated from the vertical portion of the door frame F, and thus the distance or space preserved for objects, including hands, fingers or animals, to pass unharmed when an attempt to close the door D is made but too much force is exerted on the door.

It is further envisioned that a fourth pathway may be provided. The fourth pathway may described as being curvilinear in two different and perpendicular directions, wherein the fourth pathway allows a user to “lock” the device in a fixed state, including the state of having the second member 14 extended so as to operate as a firm door stop and inhibit the door D from closing. It is envisioned that the fourth pathway is optional, and may be provided as a branch or artery from another pathway, including the third pathway 18c.

As depicted in FIG. 9, and in another embodiment, the guide 18 may have only a first pathway 18a and a third pathway 18c, and in which the corner or edge at which the first pathway 18a and the third pathway 18c meet is defined as the abutment or deflector 42. Thus, when the door D strikes the second member 14, the second member 14 and dowel pin 20 will travel a short distance before the abutment or deflector 42 and the adjacent wall will inhibit further movement, thereby stopping the door D from traveling to a closing position.

The spring 16 is placed or positioned so that torque T energy is exerted along the length of the spring 16, wherein the torque T urges movement of the second member 14 and the dowel pin 20 within the first pathway 18a of the guide 18 so that the door may be closed. The ends 16a and 16b of the spring 16 are placed in the holes 32 and 44 of the first member 12 and the second member 14, respectively, wherein the holes 32 and 44 are positioned so that the spring 16 is rotated to possess and store energy in the form of torque T.

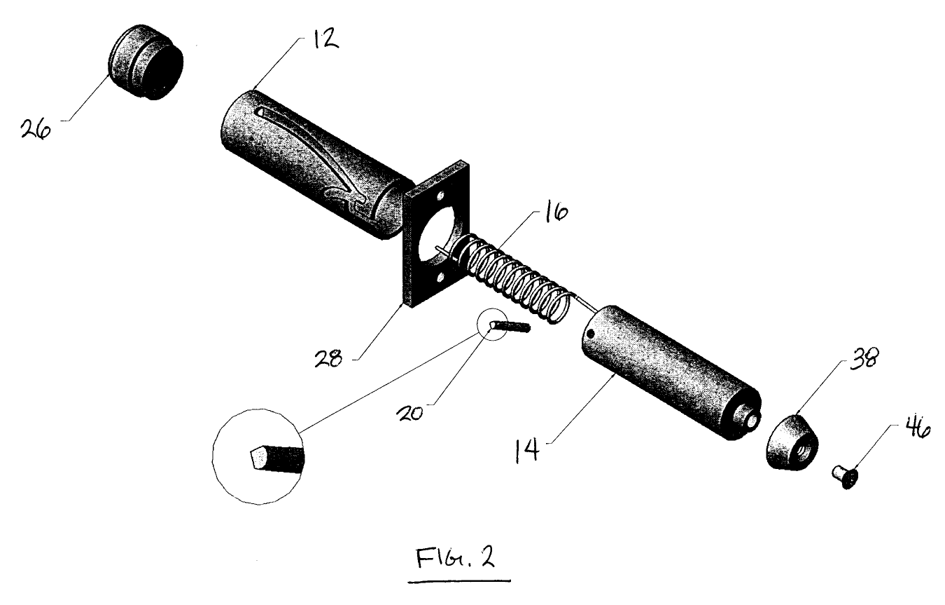

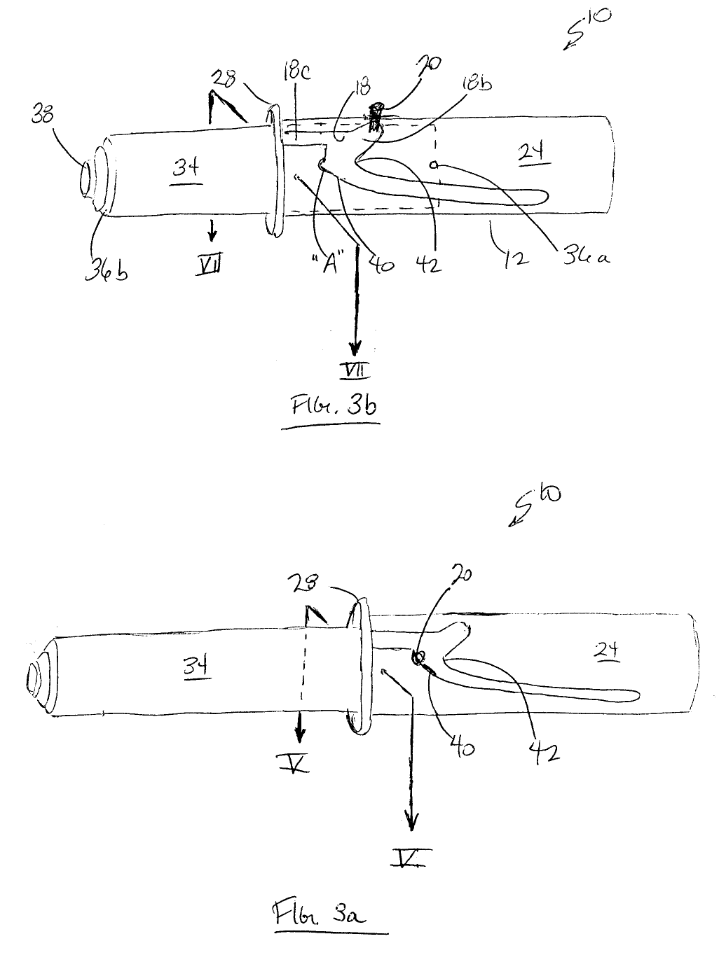

The dowel pin 20 is aligned and positioned so as to project from the second member 14 in an orientation perpendicular to an imaginary central axis running from end to end of the second member 14. It is envisioned that the dowel pin 20 may have a variety of sizes and dimensions, provided that the length and diameter are sufficient to allow the dowel pin 20 to fluidly move within the guide 18 and the corresponding pathways 18a-18c and/or 18d without inadvertently withdrawing from the guide 18 or obstructing its own movement. In one embodiment, and serving as only one example, the dowel pin 20 may have a length sufficient for the dowel pin 20 to extend approximately 3/16ths of an inch beyond the exterior of the second member 14. The dowel pin 20 is envisioned as having a substantially cylindrical body (as depicted in FIG. 3b and FIG. 5-8), or, the dowel pin 20 is envisioned as having a tear drop shaped body if viewing the pin 20 from a top or bottom view (as depicted in FIG. 10) or in a cross-section thereof. In the tear drop shaped version of dowel pin 20, the surface has a rounded or radius portion 20a of the pin 20 that sets adjacent to the starting position of the pin 20 and laterally adjacent to the deflector 42. The surface having the pointed or edged surface 20b of the pin 20 sets adjacent to the deflector 42. The pointed or edged surface 20b is provided with the intent of reducing the damage that may be inflicted by the deflector 42 onto the pin 20, generally, during the course of operation. In operation, the tear shape of the pin 20 will cause the deflector 42 to impact the pin 20 and glance and disperse the energy through the pin 20, rather than an at a specific position or point on the pin 20. For instance, the pointed or edged surface 20b will move toward the deflector 42 (when momentum is sufficient to overcome the torque T on the spring), and the deflector 42 will impact or strike the pin 20 at point 20b and/or along a surface 20c, which will absorb much of the impact energy along the length of the surface and then throughout the pin 20. As such, no specific point or location on the pin 20 will be subjected to high levels of stress, and thus preserve the life span of the pin 20.

It is further envisioned that the mounting flange 28 may be mounted in a number of positions or orientations, including inside the door frame F so that the safety apparatus 10 will contact a sliding door D at an exterior vertical portion of the door D. It is also envisioned that the mounting flange 28 may be mounted on the outside or exterior of the door frame F and aligned so as to function in stopping a hinged door D, as well. It is further envisioned that the safety apparatus 10 may be employed with other objects or apparatuses, including windows or other similar objects that may require an apparatus for slowing or inhibiting closure of an opening in the manner similar to that of a door or window.

As is depicted in FIG. 1, it is further envisioned that in conjunction with the safety apparatus 10, and especially for usage with sliding doors that have a metallic exterior vertical portion, a magnet 48 may be provided and oriented in the door frame F to attract the door and prevent the device from opening an extremely free moving door D. For instance, over time, some sliding doors D will become easily moved as the track and/or parts wear down, and thus, the safety apparatus 10 (which a starting/return position of being extended because of the outwardly biased spring 16) may open such a free moving door D as the safety apparatus 10 returns to the return position. The magnet 48 will provide protection against such a contingency.

The safety apparatus 10 may be installed on doors D during the initial fabrication process or may be retrofitted to an existing door D. One method of installation that is envisioned is for the fabricator or the end user to cut a hole in the door frame F and into the wall structure adjacent to and behind the door frame F, thus forming a recess into which the first member 12 is placed. The mounting flange 28 will rest against or abut the vertical portion of the door frame F. Attachment means 52, such as screws, nails, bolts or other similar objects, are then used to secure the mounting flange 28 to the door frame F and the wall structure. The safety apparatus 10 may be mounted in this manner with the second member 14 coupled to the first member 12 or removed from the first member 12, whichever may be most convenient and efficient. If the safety apparatus 10 is mounted so that the second member 14 is removed from the first member 12, then after the first member 12 and mounting flange 28 are coupled to the door frame F and wall structure, then the second member 14 may be coupled to the first member 12 by coupling of the spring 16 to the second member 14 in a manner consistent with that described above, and then positioning the second member 14 within the first member 12 so that the dowel pin 20 engages and communicates with the guide 18, and specifically so that the dowel pin 20 is positioned at starting position “A” within the guide.

More specifically, and in accordance with one of the embodiments depicted herein, the safety apparatus 10 installed within the door frame operates so that when the door is pushed or urged toward a closed position, if too much force is exerted on the door, the force on the door will overcome the torque T energy placed on the spring 16, and the dowel pin 20 will bypass the bumper 40 and will engage the abutment or deflector 42. If a second pathway 18b is provided, the dowel pin 20 will travel from starting position “A” toward position “C”, and thus prevent the door from closing, and will instead stop the door a predetermined distance away from the door frame (for examples, two inches). If a second pathway is not provided, then the dowel pin 20 will travel the distance from the starting position “A” to where the pin 20 engages the abutment or deflector 42, and the door will then be inhibited from engaging the door frame. When the door is no longer engaging the second member 14, the outward bias of the spring 16 will return the spring 16 to its normal and starting position, and thus return the second member 14 to a normal and starting position oriented outside of the recess 22 of first member 12. Conversely, if the door is pushed or urge with a force below the threshold necessary to overcome the torque T energy, then when the door engages the second member 14, the torque T energy stored by the spring 16 will act upon the dowel pin 20 so as to oriented the dowel pin 20 along the first pathway 18a. Initially, the dowel pin 20 will engage the adjacently positioned bumper 40, and then travel along the first pathway 18a toward position “B”, and thus permit the door to engage the door frame and close. The second member 14 will return a normal and starting position (“A”) once the door is opened sufficiently for the second member 14 to extend outwardly as urged by the outwardly biased spring 16.

It is envisioned that the materials used in the manufacture or fabrication of the safety apparatus 10 may come from a variety of sources, generally including metal, plastic, rubber and/or wood, separately or in combination. It is envisioned that a hardened plastic composite material may be most beneficial, as such a material would lower the cost of manufacture when compared to metal, while providing comparable tensile strength and durability to the apparatus 10.

The safety apparatus 10 may be provided in any variety of colors or color combinations, and may include the use of decorative elements and materials to coordinate with the decor of the door D, the door frame F, the handle and/or trim and other portions of the surrounding surfaces and area. For instance, and as an example only, if the safety apparatus 10 has a strike plate 38, the strike plate 38 may be manufactured from brass or may have a brass appearance to coordinate with the brass or brass appearance of a kick plate or the handle or other element of the door D. This allows the user flexibility in choosing and matching a safety apparatus 10 that best blends with the existing decor of the door and/or room.

What is claimed is:

1. A safety apparatus for a door comprising:
a first member mounted to a door frame and a second member communicating within the first member in response to an outwardly biased spring;
a guide formed on a wall of the first member;
a dowel pin projecting from the second member, the dowel pin communicating with the guide;
the guide having at least a first pathway receiving the dowel pin to permit the door to close; and
the spring having torque along the length of the spring for urging movement of the pin within the first pathway so that the door may close.

2. The apparatus of claim 1, wherein the first member has a flange for mounting the first member to the door frame.

3. The apparatus of claim 1, wherein the first member has a hole for receiving one end of the spring.

4. The apparatus of claim 1, wherein the second member has a hole for receiving one end of the spring.

5. The apparatus of claim 1, wherein the second member has a face that engages the door when urged toward the safety apparatus.

6. The apparatus of claim 1, wherein an end of the spring is coupled to the first member and an opposing end of the spring coupled to the second member, the coupling of the spring is oriented so that torque is generated and stored until the door engages the second member, and the momentum and force of the door is not sufficient to overcome the torque and the spring urges the dowel pin into the first pathway and permits closure of the door.

7. The apparatus of claim 6, wherein the momentum and force of the door is sufficient to overcome the torque and the spring urges the dowel pin away from the first pathway and inhibits closure of the door.

8. A safety apparatus for a door comprising:
a first member having a recess and a guide formed in a wall of the first member, the first member mounted to a door frame;
a second member communicating with the recess in response to an outwardly biased spring housed in the recess and coupled to the first member and the second member;
a dowel pin projecting from a wall of the second member, the dowel pin communicating with the guide;
the guide having at least a first pathway and a second pathway, the first pathway receiving the dowel pin to allow the door to close, and the second pathway receiving the dowel pin to inhibit the door from closing; and
the spring coupled to a closed end of the first member and a closed end of the second member communicating with the recess, the spring having torque along the length of the spring for urging movement of the pin within the first pathway so that the door may close.

9. The apparatus of claim 8, wherein the first member has a flange for mounting the first member to the door frame.

10. The apparatus of claim 8, wherein the second member has a face that engages the door when urged toward the safety apparatus.

11. The apparatus of claim 8, wherein the coupling of the spring is oriented so that torque is generated and stored until the door engages the second member, and whereby the momentum and force of the door is not sufficient to overcome the torque and the spring urges the dowel pin into the first pathway and permits closure of the door.

12. The apparatus of claim 11, wherein the momentum and force of the door is sufficient to overcome the torque and the spring urges the dowel pin into the second pathway and inhibits closure of the door.

13. The apparatus of claim 8, wherein the dowel pin has a tear-shape cross section.

14. A safety apparatus for a door comprising:
a first member having at least one wall upstanding from an enclosed end defining a recess, the first member having a guide formed in the at least one wall, the first member mounted to a door frame;
a second member having at least one wall upstanding from enclosed and opposing ends, the second member placed within the recess of the first member, the second member reciprocating within the recess in response to an outwardly biased spring housed in the recess and coupled to the first member and the second member;
a dowel pin projecting from the at least one wall of the second member, the dowel pin communicating with the guide;
the guide having three pathways, the first pathway receiving the dowel pin to allow the door to close, the second pathway receiving the dowel pin to inhibit the door from closing, and the third pathway receiving the dowel pin to release the dowel pin from the guide for removing the second member from the first member; and
the spring coupled to the closed end of the first member and the closed end of the second member communicating with the recess, the spring positioned having torque along the length of the spring, wherein the torque urges movement of the pin within the first pathway so that the door may close.

15. The apparatus of claim 14, wherein the first member has a flange for mounting the first member to the door frame.

16. The apparatus of claim 14, wherein the second member has a face that engages the door when urged toward the safety apparatus.

17. The apparatus of claim 14, wherein the face has a strike plate.

18. The apparatus of claim 14, wherein the dowel pin has a tear-shape cross section.

19. The apparatus of claim 14, wherein the coupling of the spring is oriented so that torque is generated and stored until the door engages the second member, and whereby the momentum and force of the door is not sufficient to overcome the torque and the spring urges the dowel pin into the first pathway and permits closure of the door.

20. The apparatus of claim 14, wherein the momentum and force of the door is sufficient to overcome the torque and the spring urges the dowel pin into the second pathway and inhibits closure of the door.
